(19) United States
(12) Patent Application Publication
(10) Pub. No.: US 2024/0316455 A1
(43) Pub. Date: Sep. 26, 2024

(54) PROCESSING INFORMATION FOR VIRTUAL ENVIRONMENT

(71) Applicant: Tencent Technology (Shenzhen) Company Limited, Shenzhen (CN)

(72) Inventor: Yinglei WANG, Shenzhen (CN)

(73) Assignee: Tencent Technology (Shenzhen) Company Limited, Shenzhen (CN)

(21) Appl. No.: 18/734,934

(22) Filed: Jun. 5, 2024

Related U.S. Application Data
(63) Continuation of application No. PCT/CN2023/091436, filed on Apr. 28, 2023.

(30) Foreign Application Priority Data
Jun. 23, 2022 (CN) 202210719002.0

(51) Int. Cl. A63F 13/525; A63F 13/53; G02B 27/01; G06T 15/00

(52) U.S. Cl. CPC A63F 13/525; A63F 13/53; G02B 27/0172; G06T 15/00

(57) ABSTRACT

In some examples, a method for processing information includes generating a virtual environment image for a virtual environment that includes a virtual character carrying out an action in the virtual environment, and determining a perspective angle for displaying a heads-up display (HUD) control with the virtual environment image based on a character state of the virtual character and a region of the virtual environment image for the HUD control. The HUD control provides user interface (UI) information for controlling the virtual character. The perspective angle is an included angle between the HUD control and an imaging plane of the virtual environment image. The method also includes displaying the virtual environment image with the HUD control in the region of the virtual environment image according to the perspective angle.

### RELATED APPLICATIONS

The present application is a continuation of International Application No. PCT/CN2023/091436, entitled “ METHOD AND APPARATUS FOR PROCESSING INFORMATION IN VIRTUAL ENVIRONMENT, DEVICE, AND PROGRAM PRODUCT ” and filed on Apr. 28, 2023, which claims priority to Chinese Patent Application No. 202210719002.0, entitled “METHOD AND APPARATUS FOR DISPLAYING INFORMATION IN VIRTUAL ENVIRONMENT, DEVICE, AND PROGRAM PRODUCT” and filed on Jun. 23, 2022. The entire disclosures of the prior applications are hereby incorporated by reference.

### FIELD OF THE TECHNOLOGY

Embodiments of this disclosure relate to the field of graphical user interfaces, including a method and apparatus for processing information in a virtual environment, a device, and a program product.

### BACKGROUND OF THE DISCLOSURE

Users can operate game characters in a game program to battle against each other. The game program provides a virtual environment, and the game character is a virtual character in the virtual environment.

A virtual environment picture (also referred to as a virtual environment image in some examples) and a heads-up display (HUD) control are displayed on a terminal. The virtual environment picture is a picture obtained by observing a virtual world from a perspective of the current virtual character. The HUD control is a picture that displays related information in a game, and is usually displayed on an upper layer of the virtual environment picture. In related art, when a virtual character moves in a virtual environment, a user can obtain state information of the virtual character through a virtual environment picture and a HUD control.

However, in related art, the HUD control statically floats above the virtual environment picture, and a mode of displaying information is limited.

### SUMMARY

This disclosure provides a method and apparatus for processing information in a virtual environment, a device, and a program product, for example, to adjust different perspective angles based on different character states to display an HUD control. Example technical solutions are as follows.

According to an aspect of this disclosure, a method for processing information is provided. In some examples, a method for processing information includes generating a virtual environment image for a virtual environment that includes a virtual character carrying out an action in the virtual environment, and determining a perspective angle for displaying a heads-up display (HUD) control with the virtual environment image based on a character state of the virtual character and a region of the virtual environment image for the HUD control. The HUD control provides user interface (UI) information for controlling the virtual character. The perspective angle is an included angle between the HUD control and an imaging plane of the virtual environment image. The method also includes displaying the virtual environment image with the HUD control in the region of the virtual environment image according to the perspective angle.

According to an aspect of this disclosure, an apparatus for processing information includes processing circuitry. The processing circuitry is configured to generate a virtual environment image for a virtual environment that includes a virtual character carrying out an action in the virtual environment and determine a perspective angle for displaying a heads-up display (HUD) control with the virtual environment image based on a character state of the virtual character and a region of the virtual environment image for the HUD control. The HUD control provides user interface (UI) information for controlling the virtual character. The perspective angle is an included angle between the HUD control and an imaging plane of the virtual environment image in some examples. The processing circuitry is also configured to display the virtual environment image with the HUD control in the region of the virtual environment image according to the perspective angle.

According to another aspect of this disclosure, a computer device is provided, including a processor and a memory, the memory having at least one computer program stored therein, and the at least one computer program being loaded and executed by the processor to implement the method for processing information in a virtual environment according to the foregoing aspect.

According to another aspect of this disclosure, a non-transitory computer-readable storage medium is provided, having at least one computer program stored thereon, the at least one computer program being loaded and executed by a processor to implement the method for processing information according to the foregoing aspect.

According to another aspect of this disclosure, a computer program product is provided, including a computer program, the computer program being stored on a computer-readable storage medium; and the computer program being read from the computer-readable storage medium and executed by a processor of a computer device, to enable the computer device to perform the method for processing information in a virtual environment according to the foregoing aspect.

The technical solutions provided in this disclosure may include at least the following beneficial effects:

A virtual environment image and a heads-up display HUD control are displayed. The HUD control having different perspective angles is displayed based on a character state of a virtual character when carrying out an action in the virtual environment. This disclosure provides a new information display method. An information display mode of the HUD control is associated with the character state of the virtual character, and the HUD control is displayed based on different perspective angles, to assist a user in determining the character state of the virtual character based on the perspective angles. The HUD control is displayed to simulate a display effect of HUD in the real world. A change in a perspective angle simulates deformation of a lens caused by wind resistance when the HUD is projected on the lens in the real world. For example, in the real world, when a motorcycle accelerates, a windshield of the motorcycle, as a lens on which HUD is projected, is deformed due to air resistance. An angle change of the lens on which the HUD is projected caused by wind resistance in the real world is simulated on a terminal based on the perspective angle, so that detailed simulation of the real world is provided, thereby improving efficiency of human-computer interaction.

### BRIEF DESCRIPTION OF THE DRAWINGS

FIG. 1 is a schematic diagram of a method for processing information in a virtual environment according to an exemplary embodiment of this disclosure.

FIG. 2 is a block diagram of a structure of a computer system according to an exemplary embodiment of this disclosure.

FIG. 3 is a flowchart of a method for processing information in a virtual environment according to an exemplary embodiment of this disclosure.

FIG. 4 is a schematic diagram of a transformation process from three-dimensional space to a two-dimensional image according to an exemplary embodiment of this disclosure.

FIG. 5 is a flowchart of a method for processing information in a virtual environment according to an exemplary embodiment of this disclosure.

FIG. 6 is a schematic diagram of displaying HUD controls in different perspective angles according to an exemplary embodiment of this disclosure.

FIG. 7 is a schematic diagram of an interface of processing information in a virtual environment according to an exemplary embodiment of this disclosure.

FIG. 8 is a schematic diagram of displaying HUD controls in different perspective angles according to an exemplary embodiment of this disclosure.

FIG. 9 is a schematic diagram of an interface of processing information in a virtual environment according to an exemplary embodiment of this disclosure.

FIG. 10 is a schematic diagram of displaying HUD controls in different perspective angles according to an exemplary embodiment of this disclosure.

FIG. 11 is a schematic diagram of HUD controls in different regions according to an exemplary embodiment of this disclosure.

FIG. 12 is a schematic diagram of a right HUD region according to an exemplary embodiment of this disclosure.

FIG. 13 is a schematic diagram of an upper HUD region according to an exemplary embodiment of this disclosure.

FIG. 14 is a schematic diagram of a lower HUD region according to an exemplary embodiment of this disclosure.

FIG. 15 is a schematic diagram of a left HUD region according to an exemplary embodiment of this disclosure.

FIG. 16 is a block diagram of a structure of a terminal for processing information in a virtual environment according to an exemplary embodiment of this disclosure.

FIG. 17 is a block diagram of an apparatus for processing information in a virtual environment according to an exemplary embodiment of this disclosure.

FIG. 18 is a schematic diagram of an apparatus structure of a computer device according to an exemplary embodiment of this disclosure.

### DESCRIPTION OF EMBODIMENTS

First, a brief introduction to terms in embodiments of this disclosure is provided below. The description of terms are merely examples and are not intended to limit the scope of the present disclosure.

Virtual environment: In an example, the virtual environment is a virtual environment displayed (or provided) when an application runs on a terminal. The virtual environment may be a simulated world of the real world, a semi-simulated and semi-fictional three-dimensional world, or a completely fictional three-dimensional world. The virtual environment may be any one of a two-dimensional virtual environment, a two-and-a-half-dimensional virtual environment, and a three-dimensional virtual environment.

Virtual character: In an example, the virtual character is a movable object in a virtual environment. The movable object may be at least one of a virtual animal and a cartoon character. In one embodiment, when the virtual environment is a three-dimensional virtual environment, the virtual character may be a three-dimensional virtual model. Each virtual character has a shape and a volume in the three-dimensional virtual environment, and occupies some space in the three-dimensional virtual environment. In one embodiment, the virtual character is a three-dimensional character based on a three-dimensional human skeleton technology. The virtual character wears different skins to implement different appearances. In some implementations, the virtual character may alternatively be implemented by using a two-and-a-half-dimensional model or a two-dimensional model, which is not limited in embodiments of this disclosure.

Heads-up display (HUD) control: In an example, the HUD control is a picture that displays related information in a game, and is usually displayed on an upper layer of a virtual environment picture. The HUD control is an effective manner for a game world to interact with players. Elements that can convey information to the players through a visual effect can be referred to as HUD. A common HUD control includes an operation control, an item bar, a map, an ammunition bar, a health bar, a scope, and the like.

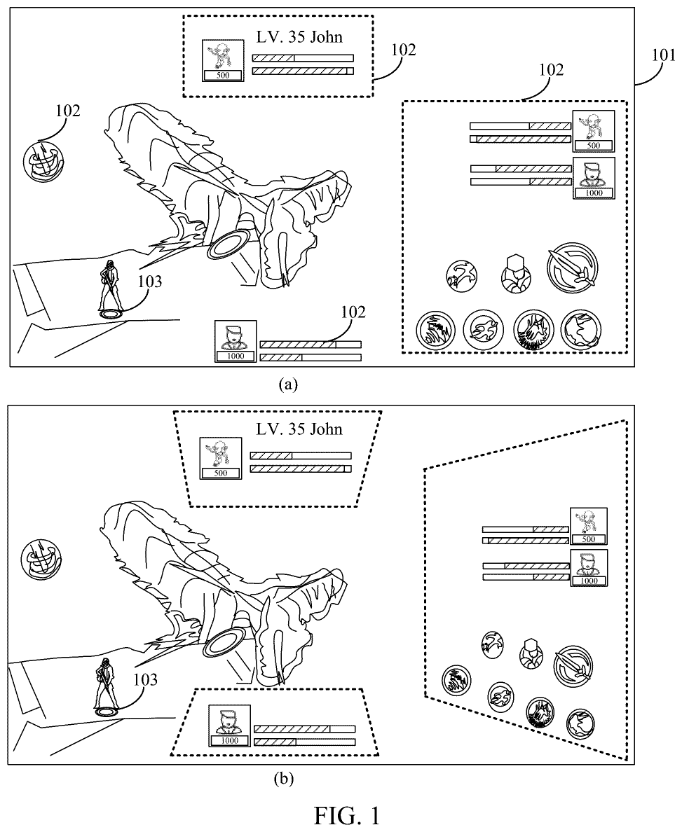

An embodiment of this disclosure provides a technical solution of a method for processing information in a virtual environment. The method can be performed by a terminal or a client on the terminal. As shown in section (a) of FIG. 1, a virtual environment picture 101 (also referred to as a virtual environment image in some examples) and a heads-up display HUD control 102 are displayed on a terminal.

The virtual environment picture 101 is for displaying a picture obtained by observing a virtual environment. The HUD control 102 is configured to display user interface UI information required for controlling a virtual character 103. The HUD control 102 is usually displayed on an upper layer of the virtual environment picture 101. The terminal displays the HUD control 102 having different perspective angles based on a character state of the virtual character 103 in the virtual environment.

The perspective angle is an included angle between the HUD control 102 and an imaging plane of the virtual environment picture 101.

In one embodiment, the HUD control 102 includes state information and an operation control of the virtual character 103, but is not limited thereto, which is not specifically limited in embodiments of this disclosure.

For example, when the virtual character 103 is in the virtual environment in a first state, the terminal displays the HUD control 102 in a first perspective angle. When the virtual character 103 is in the virtual environment in a second state, the terminal displays the HUD control 102 in a second perspective angle. As shown in section (b) of FIG. 1, the terminal changes the perspective angle of the HUD control 102 from the first perspective angle to the second perspective angle in response to the character state of the virtual character 103 changing from the first state to the second state. The first perspective angle corresponds to the first state, and the second perspective angle corresponds to the second state.

In one embodiment, the first state is a walking state, and the second state is a running state. The terminal changes the perspective angle of the HUD control 102 from the first perspective angle to the second perspective angle in response to the character state of the virtual character 103 changing from the walking state to the running state. The second perspective angle is greater than the first perspective angle. For example, when the virtual character 103 is in the walking state, the first perspective angle corresponding to the HUD control 102 is 5°. When the virtual character 103 is in the running state, the second perspective angle corresponding to the HUD control 102 is 30°. When the virtual character 103 switches from the walking state to the running state, the perspective angle of the HUD control 102 switches from 5° to 30°.

For example, the terminal changes the perspective angle of the HUD control 102 in response to an attribute parameter change of the character state of the virtual character 103.

In one embodiment, the terminal increases the perspective angle of the HUD control 102 in response to an increase in speed or acceleration of the virtual character 103 in the virtual environment. The terminal decreases the perspective angle of the HUD control 102 in response to a decrease in speed or acceleration of the virtual character 103 in the virtual environment. For example, when the virtual character 103 is parachuting or flying, the terminal increases the perspective angle of the HUD control 102 in response to an increase in speed or acceleration of the virtual character 103 in the virtual environment.

For example, the terminal displays the HUD control 102 in a dynamically changing perspective angle in response to the character state of the virtual character 103 being a third state.

The dynamically changing perspective angle is within a range of a third perspective angle corresponding to the third state.

In one embodiment, the third state is an attacked state. The terminal displays, in response to the character state of the virtual character 103 in the virtual environment being the attacked state, the HUD control 102 in a perspective angle changing in a periodically shaking manner.

For example, when the virtual character 103 is attacked in the virtual environment, the terminal dynamically displays the HUD control 102 within the range of the third perspective angle. For example, when the virtual character 103 is in the attacked state, the range of the third perspective angle is 0° to 30°, and in this case, the HUD control 102 dynamically changes and displays between 0° and 30°.

In a possible implementation, the HUD control 102 includes an operation control. The terminal displays the HUD control 102 having different perspective angles in response to a trigger operation of the operation control.

For example, the operation control includes a first type of operation control. The terminal changes, in response to a trigger operation of the first type of operation control, the perspective angle of the HUD control 102 to a corresponding perspective angle after the first type of operation control is triggered.

For example, the operation control includes a second type of operation control. The terminal displays the HUD control 102 in a dynamically changing perspective angle in response to a trigger operation of the second type of operation control. The dynamically changing perspective angle is within a range of a perspective angle corresponding to the second type of operation control.

In conclusion, in the method provided in this embodiment, a virtual environment picture and a heads-up display HUD control are displayed; a virtual character is controlled to carry out an action in a virtual environment; and the HUD control having different perspective angles is displayed based on a character state of the virtual character. This disclosure provides a new information display method. An information display mode of the HUD control is associated with the character state of the virtual character, and the HUD control is displayed based on different perspective angles, to assist a user in determining the character state of the virtual character based on the perspective angles, thereby improving efficiency of human-computer interaction and user experience.

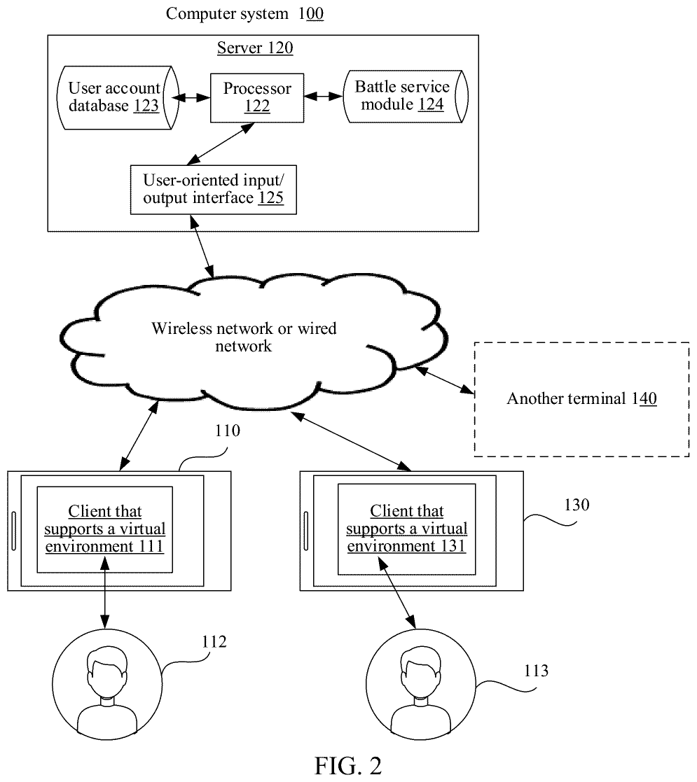

FIG. 2 is a block diagram of a structure of a computer system according to an exemplary embodiment of this disclosure. The computer system 100 includes a first terminal 110, a server 120, and a second terminal 130.

A client 111 that supports a virtual environment is installed and run on the first terminal 110. The client 111 may be a multiplayer online battle program. When the first terminal runs the client 111, a user interface of the client 111 is displayed on a screen of the first terminal 110. The client 111 may be any one of a battle royale shooting game, a virtual reality (VR) application, an augmented reality (AR) program, a three-dimensional map program, a virtual reality game, an augmented reality game, a first-person shooting game (FPS), a third-personal shooting game (TPS), a multiplayer online battle arena game (MOBA), or a simulation game (SLG). In this embodiment, an example in which the client 111 is a MOBA game is used for description. The first terminal 110 is a terminal used by a first user 112. The first user 112 uses the first terminal 110 to control a first virtual character in the virtual environment to carry out an action. The first virtual character may be referred to as a virtual character of the first user 112. The first user 112 may perform an operation, such as assembling, disassembling, and unloading, on a virtual item owned by the first virtual character, which is not limited in this disclosure. For example, the first virtual character is a first virtual character such as a simulation character or a cartoon character.

A client 131 that supports a virtual environment is installed and run on the second terminal 130. The client 131 may be a multiplayer online battle program. When the second terminal 130 runs the client 131, a user interface of the client 131 is displayed on a screen of the second terminal 130. The client may be any one of a battle royale shooting game, a VR application, an AR program, a three-dimensional map program, a virtual reality game, an augmented reality game, an FPS, a TPS, a MOBA, or an SLG. In this embodiment, an example in which the client is a MOBA game is used for description. The second terminal 130 is a terminal used by a second user 113. The second user 113 uses the second terminal 130 to control a second virtual character in the virtual environment to carry out an action. The second virtual character may be referred to as a virtual character of the second user 113. For example, the second virtual character is a second virtual character such as a simulation character or a cartoon character. In one embodiment, the first virtual character and the second virtual character are in the same virtual environment. In one embodiment, the first virtual character and the second virtual character may belong to the same camp, the same team, the same organization, have a friend relationship, or have temporary communication permissions. In one embodiment, the first virtual character and the second virtual character may belong to different camps, different teams, different organizations, or have an adversarial relationship.

In one embodiment, the clients installed on the first terminal 110 and the second terminal 130 are the same, or the clients installed on the two terminals are clients of the same type on different operating system platforms (Android or IOS). The first terminal 110 may generally be one of a plurality of terminals, and the second terminal 130 may generally be another one of the plurality of terminals. This embodiment only uses the first terminal 110 and the second terminal 130 as examples. Device types of the first terminal 110 and the second terminal 130 are the same or different. The device type includes at least one of a smart phone, a tablet, an e-book reader, an MP3 player, an MP4 player, a portable laptop computer, and a desktop computer. FIG. 2 only shows two terminals. However, there are a plurality of terminals 140 that can access the server 120 in different embodiments. In one embodiment, there are alternatively one or more terminals 140 that correspond to a developer. A development and editing platform for a client that supports a virtual environment is installed on the terminal 140. The developer may edit and update the client on the terminal 140, and transmit an updated client installation package to the server 120 over a wired or wireless network. The first terminal 110 and the second terminal 130 may download the client installation package from the server 120 to update the client.

The first terminal 110, the second terminal 130, and the another terminal 140 are connected to the server 120 over a wireless network or a wired network. The server 120 includes at least one of a server, a plurality of servers, a cloud computing platform, and a virtualization center. The server 120 is configured to provide a background service for a client that support a three-dimensional virtual environment. In one embodiment, the server 120 is responsible for primary computing work, and the terminals are responsible for secondary calculation work. Alternatively, the server 120 is responsible for secondary computing work, and the terminals are responsible for computing work. Alternatively, a distributed computing architecture may be used between the server 120 and the terminals for collaborative computing.

For example, the server 120 includes a processor 122, a user account database 123, a battle service module 124, and a user-oriented input/output interface (I/O interface) 125. The processor 122 is configured to load instructions stored in the server 120 and process data in the user account database 123 and the battle service module 124. The user account database 123 is configured to store data of user accounts used by the first terminal 110, the second terminal 130, and the another terminal 140, for example, avatars of the user accounts, nicknames of the user accounts, combat effectiveness indexes of the user accounts, and service zones of the user accounts. The battle service module 124 is configured to provide a plurality of battle rooms for users to battle, for example, 1V1 battle, 3V3 battle, and 5V5 battle. The user-oriented I/O interface 125 is configured to establish communication with the first terminal 110 and/or the second terminal 130 over a wireless network or a wired network for data exchange.

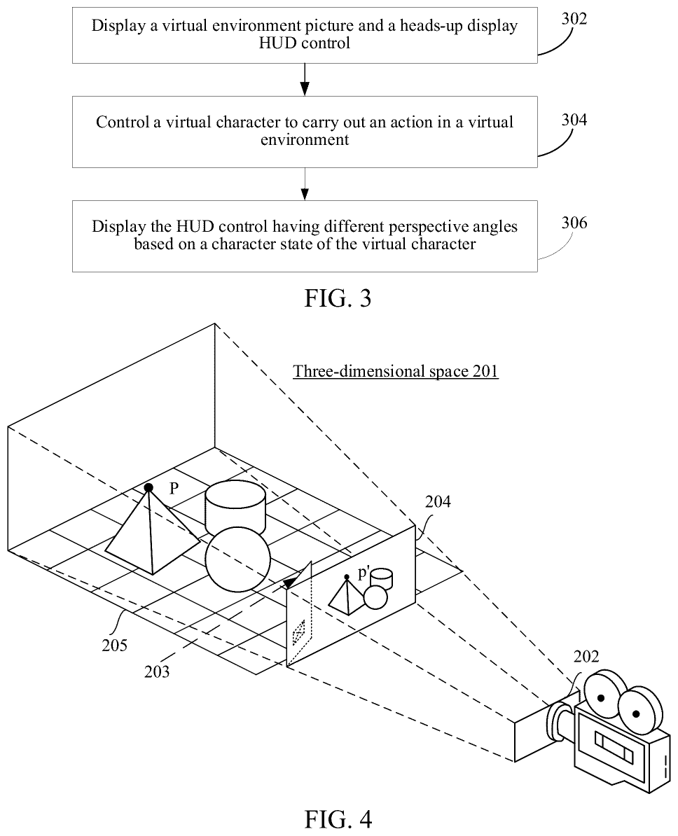

FIG. 3 is a flowchart of a method for processing information in a virtual environment according to an exemplary embodiment of this disclosure. The method may be performed by the terminal in the system shown in FIG. 2 or the client on the terminal. The method includes the following operations:

Operation 302: Display a virtual environment picture and a heads-up display HUD control.

The virtual environment picture is for displaying a picture obtained by observing a virtual environment. The HUD control is configured to display user interface UI information required for controlling a virtual character. In one embodiment, the HUD control includes at least one of an operation control, an item bar, a map, an ammunition bar, a health bar, and a scope, but is not limited thereto, which is not limited in embodiments of this disclosure.

In one embodiment, the HUD control floats and is displayed on an upper layer of the virtual environment picture. Alternatively, the HUD control floats and is displayed on an upper layer of the virtual environment picture in a default perspective angle. The default perspective angle depends on a current character state of the virtual character. Alternatively, the HUD control floats and is displayed on an upper layer of the virtual environment picture in a dynamic perspective angle, but is not limited thereto, which is not specifically limited in embodiments of this disclosure.

In one embodiment, the virtual environment picture is a picture obtained by observing the virtual environment. An imaging plane of the virtual environment picture is formed by obtaining model information of a three-dimensional virtual model of the virtual environment and rendering the three-dimensional virtual model into a screenshot.

The perspective angle is an included angle between the HUD control and the imaging plane of the virtual environment picture.

In one embodiment, the perspective angle is an included angle between a single HUD control and the imaging plane of the virtual environment picture. Alternatively, the perspective angle is an included angle between a plane where all HUD controls are located and the imaging plane of the virtual environment picture. Alternatively, the perspective angle is an included angle between a plane where HUD controls included in some regions are located and the imaging plane of the virtual environment picture. However, this is not limited thereto. The virtual environment is an environment where the virtual character is in a virtual world during running of an application on the terminal. In embodiments of this disclosure, the virtual character is observed by using a camera model in the virtual world.

In one embodiment, the camera model automatically follows the virtual character in the virtual world. To be specific, when a position of the virtual character in the virtual world changes, the camera model changes simultaneously with the position of the virtual character in the virtual world, and the camera model is always within a preset distance range of the virtual character in the virtual world. In one embodiment, in an automatic following process, a relative position between the camera model and the virtual character does not change. In an example, the imaging plane is a plane perpendicular to a photographing direction of the camera model. For example, when the camera model uses a third-person perspective to photograph in a top view, the imaging plane is a horizontal plane in the virtual environment. When the camera model uses a first-person perspective to photograph in a horizontal view, the imaging plane is parallel to a vertical direction. The horizontal plane is a plane perpendicular to a simulated gravity direction in the virtual environment. The vertical direction is parallel to the simulated gravity direction in the virtual environment. For example, the camera model is also referred to as a virtual camera. The photographing direction pointed by the camera model is perpendicular to the imaging plane. The imaging plane is usually a rectangle, and also referred to as an imaging rectangle. Virtual photosensitive elements on the imaging plane are in one-to-one correspondence with pixels on a terminal screen. The virtual photosensitive element records light intensity and a color when the virtual character is observed by using the camera model. For example, the camera model is a model in computer graphics configured to observe the virtual world. For description of the camera model, reference may be made to the book Game Engine Architecture (2^{nd} Edition) written by Jason Gregory (USA), published by Publishing House of Electronics Industry in February 2019, and translated by Milo Yip, including but not limited to content of Foundations of Depth-Buffered Triangle Rasterization in Section 10.1 of Chapter 10, especially content of Virtual Camera in Section 10.1.4. Reference may also be made to the book Unity 5.X from beginner to master, published by China Railway Publishing House in January 2016 and edited by Unity Software (Shanghai) Co., Ltd., including but not limited to content related to cameras in Create Basic 3D Game Scenes in Chapter 6.

The camera model is a three-dimensional model around the virtual character in the virtual world. When the first-person perspective is used, the camera model is near the head of the virtual character or on the head of the virtual character. When the third-person perspective is used, the camera model may be behind the virtual character and bound to the virtual character, or may be located at any position from the virtual character by a preset distance. The virtual character in the virtual world may be observed from different angles by using the camera model. In one embodiment, when the third-person perspective is a first-person over-shoulder perspective, the camera model is behind the virtual character (for example, the head and shoulders of the virtual character). In one embodiment, in addition to the first-person perspective and the third-person perspective, another perspective is also included, such as a top view perspective. When the top view perspective is used, the camera model may be above the head of the virtual character. The top view perspective is a perspective for observing the virtual world from a perspective of looking down from the air. In one embodiment, the camera model is not actually displayed in the virtual world. In other words, the camera model is not displayed in the virtual world displayed in a user interface.

An example in which the camera model is located at any position from the virtual character by a preset distance is used for description. In one embodiment, one virtual character corresponds to one camera model. The camera model may rotate with the virtual character as a rotation center. For example, the camera model rotates with any point of the virtual character as the rotation center. During rotation, the camera model not only rotates in angle, but also deviates in displacement. A distance between the camera model and the rotation center remains unchanged during rotation. In other words, the camera model rotates on a surface of a sphere with the rotation center as the center of the sphere. Any point of the virtual character may be the head or the torso of the virtual character, or any point around the virtual character, which is not limited in embodiments of this disclosure. In one embodiment, when the camera model observes the virtual character, a center orientation of the perspective of the camera model is a direction of a point of a sphere surface where the camera model is located pointing to the sphere center. In one embodiment, the camera model may alternatively observe the virtual character in a preset angle in different directions of the virtual character.

Operation 304: Control the virtual character to carry out an action in the virtual environment.

The virtual character is a virtual character controlled by an account logged in to the terminal. An object uses an operation control to control the virtual character to carry out an action in the virtual environment. The object may control, by pressing a button or buttons in one or more operation controls, the virtual character to carry out an action. The action includes but is not limited to at least one of adjusting a body posture, walking, running, jumping, cycling, driving, aiming, and picking up and using a throwing item, which is not limited in embodiments of this disclosure.

In one embodiment, the object may control, by pressing the button or the buttons in the one or more operation controls, the virtual character to cast a skill or use an item. The object may alternatively control the virtual character through signals generated by long pressing, a tapping/clicking, double tapping/clicking, and/or sliding on a touch screen. In one embodiment, a manner of controlling the virtual character to carry out an action includes: the object controls, by using at least one of a virtual joystick, a virtual switch, and a virtual button on a terminal interface, the virtual character to carry out an action; the object controls, by using an external device (such as a handle, VR glasses, or a VR helmet) connected to the terminal, the virtual character to carry out an action; the object controls, through voice, the virtual character to carry out an action; and the object controls, through a motion sensing operation, the virtual character to carry out an action. The manner of controlling the virtual character to carry out an action is not specifically limited in this disclosure. For example, the HUD control is configured to display the user interface UI information required for controlling the virtual character. The HUD control may be configured to control the virtual character to carry out an action, and may alternatively be configured to display information related to at least one of a virtual environment, a virtual object in the virtual environment, and a virtual character in the virtual environment, which is not limited in this embodiment.

Operation 306: Display the HUD control having different perspective angles based on a character state of the virtual character.

The perspective angle is an included angle between the HUD control and the imaging plane of the virtual environment picture.

The character state is a state of the virtual character in the virtual environment, such as a walking state, a running state, and an attacked state, but is not limited thereto, which is not specifically limited in embodiments of this disclosure. In one embodiment, the character state is a state related to the virtual character. Alternatively, the character state is a state presented when the virtual character interacts with another virtual character and another virtual item in the virtual environment. Alternatively, the character state is a motion state, a health state, and a level state of the virtual character. However, this is not limited thereto.

The terminal displays the HUD control having different perspective angles on the terminal based on a change of the character state of the virtual character. Specifically, when the character state of the virtual character is a first state, the HUD control having a first perspective angle is displayed. When the character state of the virtual character is a second state, the HUD control having a second perspective angle is displayed. The first state and the second state are different character states. When the character state of the virtual character is the first state, a plurality of HUD controls may have the same or different perspective angles.

In this disclosure, the HUD control having different perspective angles is displayed based on the character state of the virtual character. A user can obtain at least one of movement speed and acceleration information of the virtual character by observing the HUD control. Accurate simulation of the real world is provided, and a display effect of a transparent plate affected by air resistance during moving when the HUD control is displayed by using the transparent plate made of materials such as plastics is simulated, to provide better simulation of the real world.

In conclusion, in the method provided in this embodiment, a virtual environment picture and a heads-up display HUD control are displayed; The HUD control having different perspective angles is displayed based on a character state of a virtual character when carrying out an action in a virtual environment. This disclosure provides a new information display method. An information display mode of the HUD control is associated with the character state of the virtual character, and the HUD control is displayed based on different perspective angles, to assist a user in determining the character state of the virtual character based on the perspective angles. The HUD control is displayed to simulate a display effect of HUD in the real world. A change in a perspective angle simulates deformation of a lens caused by wind resistance when the HUD is projected on the lens in the real world. For example, in the real world, when a motorcycle accelerates, a windshield of the motorcycle, as a lens on which HUD is projected, is deformed due to air resistance. An angle change of the lens on which the HUD is projected caused by wind resistance in the real world is simulated on a terminal based on the perspective angle, so that detailed simulation of the real world is provided, thereby improving efficiency of human-computer interaction.

In an implementation, the virtual environment is an environment where the virtual character is in a virtual world during running of an application on the terminal. The virtual environment is three-dimensional space. A world space coordinate system is configured for describing coordinates of a three-dimensional model in the virtual environment in the same scene. The three-dimensional model is an object in the virtual environment.

For example, the world space coordinate system may be obtained by transforming the three-dimensional model in a model space coordinate system through a model transformation matrix. The model space coordinate system is configured for indicating position information of the three-dimensional model. Coordinate information of three-dimensional models in the model space coordinate system is unified into the world space coordinate system in the three-dimensional space through the model transformation matrix.

For example, the three-dimensional model in the world space coordinate system is converted into a camera space coordinate system through a view matrix. The camera space coordinate system is configured for describing coordinates of a three-dimensional model observed by using a camera model, for example, using a position of the camera model as a coordinate origin. The three-dimensional model in the camera space coordinate system is converted into a clip space coordinate system through a projection matrix. The clip space coordinate system is configured for describing a projection of a three-dimensional model in a viewing frustum of the camera model. A commonly used perspective projection matrix (a projection matrix) is configured for projecting a three-dimensional model into a model that conforms to a human eye observation rule of “near-large and far-small”. For example, the foregoing model transformation matrix, view matrix, and projection matrix are usually collectively referred to as a model view projection (MVP) matrix.

It is noted that the flowchart can be suitably adjusted into other forms. In some examples, the flowchart includes a first step of generating a virtual environment picture for a virtual environment that includes a virtual character carrying out an action in the virtual environment, and a second step of determining a perspective angle for displaying a heads-up display (HUD) control with the virtual environment picture based on a character state of the virtual character and a region of the virtual environment picture for the HUD control. The HUD control provides user interface (UI) information for controlling the virtual character. The perspective angle is an included angle between the HUD control and an imaging plane of the virtual environment picture. The flowchart also includes a third step of displaying the virtual environment picture with the HUD control in the region of the virtual environment picture according to the perspective angle.

FIG. 4 is a schematic diagram of a transformation process from three-dimensional space to a two-dimensional image according to an exemplary embodiment of this disclosure. A process of mapping a feature point P in three-dimensional space 201 to a feature point p′ in an imaging plane 204 (an image coordinate system, or referred to as a pixel coordinate system) is shown with reference to FIG. 4. Coordinates of the feature point P in the three-dimensional space 201 are in a three-dimensional form, and coordinates of the feature point p′ in the imaging plane 204 are in a two-dimensional form. The three-dimensional space 201 is three-dimensional space corresponding to a virtual environment. A camera plane 202 is determined by a posture of a camera model. The camera plane 202 is a plane perpendicular to a photographing direction of the camera model. The imaging plane 204 and the camera plane 202 are parallel to each other. The imaging plane 104 is a plane on which a virtual environment located within a field of view is imaged by the camera model when the virtual environment is observed.

Further, a perspective angle is configured for indicating an included angle between a plane 203 where an HUD control is located and the imaging plane 204. The perspective angle is the included angle between the two planes. The included angle is an included angle between projections on a reference plane 205. The plane 203 where the HUD control is located is a plane of the HUD control displayed by a terminal in the three-dimensional space corresponding to the virtual environment. The imaging plane 204 is in a vertical relationship with the reference plane 205, and the plane 203 where the HUD control is located is in a vertical relationship with the reference plane 205. A projection of the imaging plane 204 on the reference plane 205 is a straight line, and a projection of the plane 203 where the HUD control is located on the reference plane 205 is also a straight line. The perspective angle is an included angle between the two straight lines. Further, the perspective angle is greater than or equal to 0 degrees and less than 90 degrees. Further, the HUD control displayed on the terminal is obtained by observing the plane 203 where the HUD control is located by using the camera model. An observation direction of the camera is perpendicular to the imaging plane 204. In the figure, for case of representing the plane 203 where the HUD control is located, some edges of the plane are shown by using dotted lines. A rectangular HUD control is displayed on the plane 203 where the HUD control is located, and is also shown by using dotted lines. To avoid confusion with other parts in the figure, diagonal lines of the HUD control are also drawn. In the figure, the reference plane 205 is a horizontal plane in the three-dimensional space 201. As a position of the camera model changes, the reference plane 205 changes to another plan accordingly. The figure only shows that at a current camera position, the reference plane 205 is the horizontal plane in the three-dimensional space 201. At the current camera position, the reference plane 205 may alternatively be another plane parallel to the horizontal plane in the three-dimensional space 201.

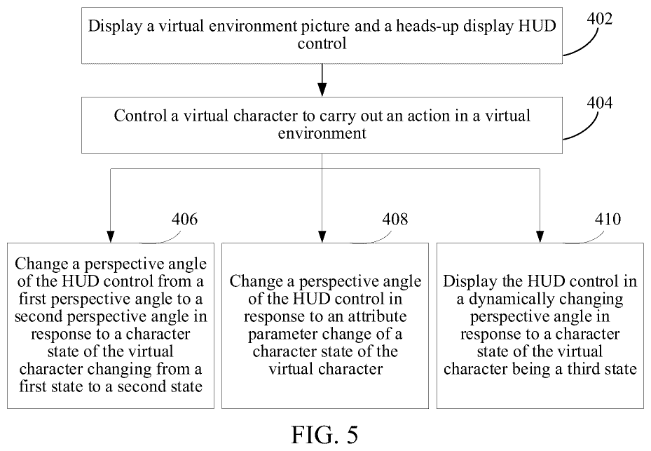

FIG. 5 is a flowchart of a method for processing information in a virtual environment according to an exemplary embodiment of this disclosure. The method may be performed by the terminal in the system shown in FIG. 2 or the client on the terminal. The method includes the following operations:

Operation 402: Display a virtual environment picture and a heads-up display HUD control.

The HUD control is configured to display user interface UI information required for controlling a virtual character. In one embodiment, the HUD control includes at least one of an operation control, an item bar, a map, an ammunition bar, a health bar, and a scope, but is not limited thereto, which is not limited in embodiments of this disclosure. In one embodiment, a virtual environment displayed on the virtual environment picture includes at least one element of a mountain, a plain, a river, a lake, an ocean, a desert, a swamp, quicksand, sky, a plant, a building, a vehicle, and a person.

Operation 404: Control the virtual character to carry out an action in the virtual environment.

An object uses an operation control to control the virtual character to carry out an action in the virtual environment. The object may control, by pressing a button or buttons in one or more operation controls, the virtual character to carry out an action. The action includes at least one of walking, running, lying down, jumping, and squatting, which is not limited in embodiments of this disclosure.

Operation 406: Change a perspective angle of the HUD control from a first perspective angle to a second perspective angle in response to a character state of the virtual character changing from a first state to a second state.

The perspective angle is an included angle between the HUD control and the imaging plane of the virtual environment picture.

The character state is a state of the virtual character in the virtual environment, such as a walking state, a running state, and an attacked state, but is not limited thereto, which is not specifically limited in embodiments of this disclosure. In an example, the character state of the virtual character is related to controlling an action of the virtual character in the virtual environment. For example, the character state of the virtual character changes to a running state by controlling the virtual character to run. In another example, the character state of the virtual character is independent of controlling the virtual character to carry out an action in the virtual environment. For example, when the virtual character is attacked virtually, the character state is an attacked state. The attacked state is caused by a virtual attack on the virtual character, and independent of controlling an action of the virtual character. For example, the terminal changes the perspective angle of the HUD control from the first perspective angle to the second perspective angle in response to the character state of the virtual character changing from the first state to the second state. The first perspective angle corresponds to the first state, and the second perspective angle corresponds to the second state.

In one embodiment, the first state is a state related to the virtual character. Alternatively, the first state is a state presented when the virtual character interacts with another virtual character and another virtual item in the virtual environment. Alternatively, the first state is a motion state, a health state, and a level state of the virtual character. However, this is not limited thereto.

In one embodiment, the second state is a state related to the virtual character. Alternatively, the second state is a state presented when the virtual character interacts with another virtual character and another virtual item in the virtual environment. Alternatively, the second state is a motion state, a health state, and a level state of the virtual character. However, this is not limited thereto.

In one embodiment, the first perspective angle corresponding to the first state means that when the virtual character is in the first state, the perspective angle of the HUD control is the first perspective angle. The second perspective angle corresponding to the second state means that when the virtual character is in the second state, the perspective angle of the HUD control is the second perspective angle.

In one embodiment, the first state and the second state each include at least one of a static state, a walking state, a running state, a flying state, a falling state, a parachuting state, a crawling state, a creeping state, a jumping state, and an injured state, but are not limited thereto, which is not specifically limited in embodiments of this disclosure. Operation 402, operation 404, and operation 406 in this embodiment may constitute a new embodiment for separate implementation, which is not limited in this implementation.

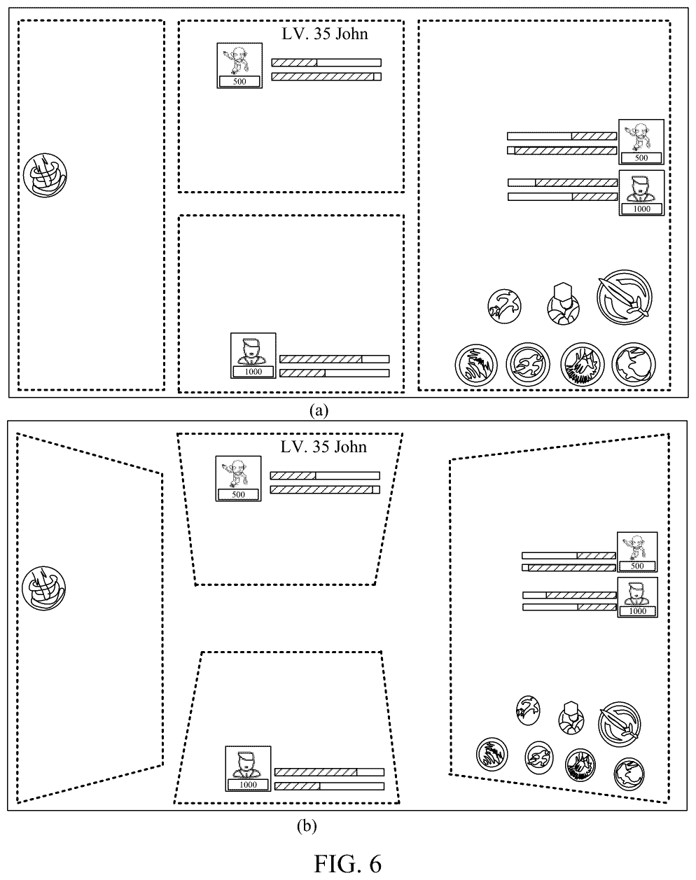

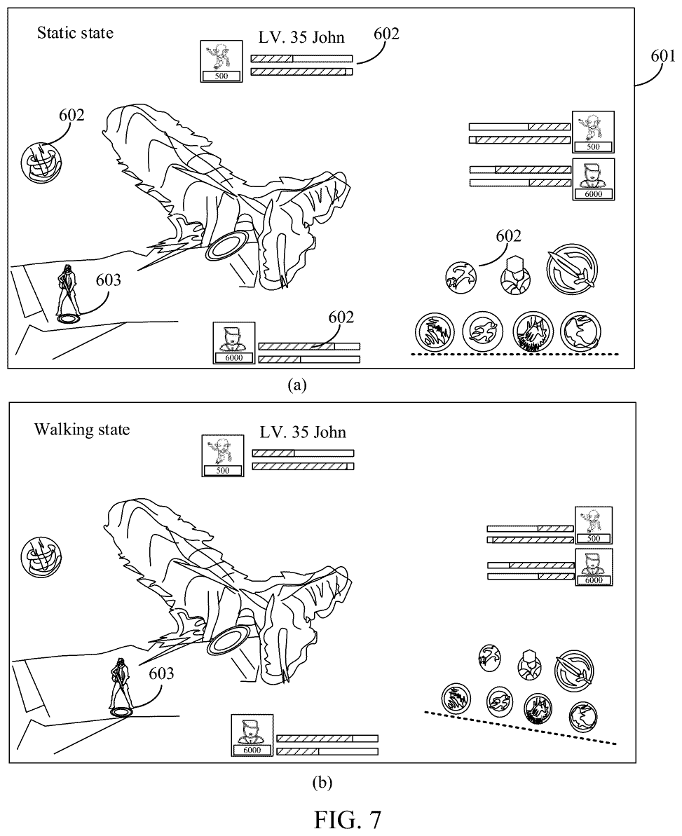

In an implementation, in operation 406, the first state is a walking state, and the second state is a running state. Operation 406 may be implemented as: The terminal changes the perspective angle of the HUD control from the first perspective angle to the second perspective angle in response to the character state of the virtual character changing from the walking state to the running state. The second perspective angle is greater than the first perspective angle. For example, when the virtual character is in the walking state, the first perspective angle corresponding to the HUD control is 5°. When the virtual character is in the running state, the second perspective angle corresponding to the HUD control is 30°. When the virtual character switches from the walking state to the running state, the perspective angle of the HUD control switches from 5° to 30°. For example, FIG. 6 is a schematic diagram of displaying n HUD controls in different perspective angles. At least one of the HUD controls including an operation control, an ammunition bar, a health bar, and virtual character information is displayed in the figure. As shown in section (a) of FIG. 6, when a virtual character is in a static state in a virtual environment, a perspective angle of the HUD controls displayed by a terminal is 0°. As shown in section (b) of FIG. 6, when the virtual character is in a walking state in the virtual environment, the perspective angle of the HUD controls displayed by the terminal is 5°. When the virtual character switches from the static state to the walking state, the perspective angle of the HUD controls switches from 0° to 5°. For example, FIG. 7 is a schematic diagram of an interface of processing information in a virtual environment. A virtual environment picture 601 and HUD controls 602 are displayed on the interface. As shown in section (a) of FIG. 7, when a virtual character 603 is in a static state in a virtual environment, the virtual environment picture 601 and the HUD controls 602 having a perspective angle of 0° are displayed on the interface. As shown in section (b) of FIG. 7, when the virtual character 603 switches from the static state to a walking state, the virtual environment picture 601 and the HUD controls 602 having a perspective angle of 5° are displayed on the interface.

Operation 408: Change the perspective angle of the HUD control in response to an attribute parameter change of the character state of the virtual character.

In one embodiment, the attribute parameter change of the character state refers to a change in an attribute parameter, such as speed and acceleration, of the virtual character in a motion state. Alternatively, the attribute parameter change of the character state refers to a change in an attribute parameter, such as an ammunition amount, a hit point, a health point, or a damage rate, of the virtual character. However, this is not limited thereto. Operation 402, operation 404, and operation 408 in this embodiment may constitute a new embodiment for separate implementation, which is not limited in this implementation.

In an implementation, operation 408 may be implemented as: The terminal increases the perspective angle of the HUD control in response to an increase in speed or acceleration of the virtual character in the virtual environment.

In an implementation, operation 408 may be implemented as: The terminal decreases the perspective angle of the HUD control in response to a decrease in speed or acceleration of the virtual character in the virtual environment. For example, when the virtual character is parachuting or flying, the terminal increases the perspective angle of the HUD control in response to the increase in speed or the acceleration of the virtual character in the virtual environment.

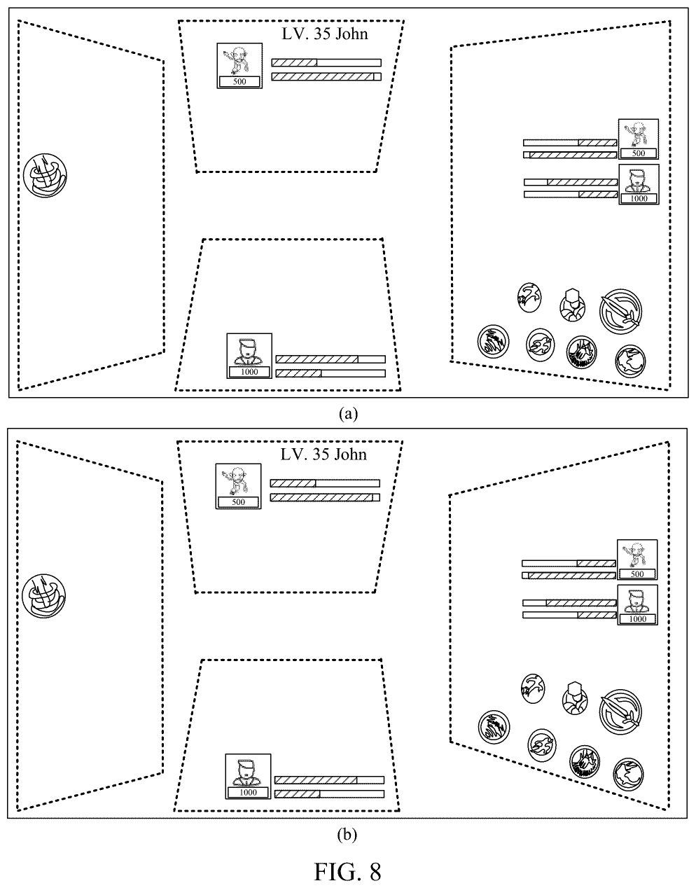

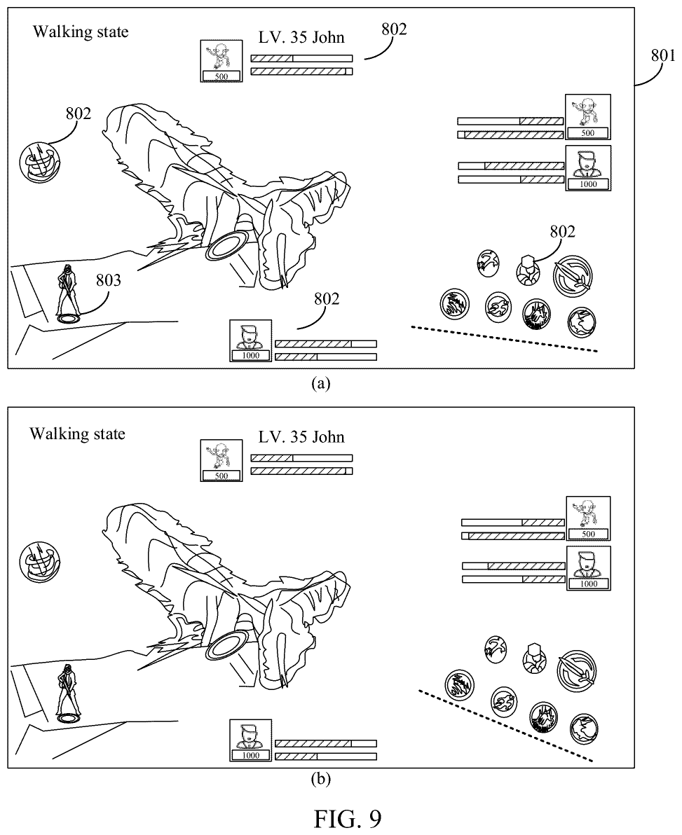

For example, FIG. 8 is a schematic diagram of displaying HUD controls in different perspective angles. At least one of the HUD controls including an operation control, an ammunition bar, a health bar, and virtual character information is displayed in the figure. As shown in section (a) of FIG. 8, when a virtual character is in a walking state in a virtual environment and walking speed is first speed, a perspective angle of the HUD controls displayed by a terminal is 10°. As shown in section (b) of FIG. 8, when the virtual character is in the walking state in the virtual environment and the walking speed is second speed, the perspective angle of the HUD controls displayed by the terminal is 35°. The second speed is greater than the first speed. When the virtual character switches from the first speed to the second speed during walking, the perspective angle of the HUD controls switches from 10° to 35°. For example, FIG. 9 is a schematic diagram of an interface of processing information in a virtual environment. A virtual environment picture 801 and an HUD controls 802 are displayed on the interface. As shown in section (a) of FIG. 9, when a virtual character 803 is in a walking state in a virtual environment and walking speed is 1 m/s, the virtual environment picture 801 and the HUD controls 802 having a perspective angle of 10° are displayed on the interface. As shown in section (b) of FIG. 9, when the virtual character 803 switches from 1 m/s to 3 m/s during walking, the virtual environment picture 801 and the HUD controls 802 having a perspective angle of 35° are displayed on the interface.

Operation 410: Display the HUD control in a dynamically changing perspective angle in response to the character state of the virtual character being a third state.

The dynamically changing perspective angle is within a range of a third perspective angle corresponding to the third state.

Operation 402, operation 404, and operation 410 in this embodiment may constitute a new embodiment for separate implementation, which is not limited in this implementation.

In one embodiment, the third state is a state related to the virtual character. Alternatively, the third state is a state presented when the virtual character interacts with another virtual character and another virtual item in the virtual environment. Alternatively, the third state is a motion state, a health state, and a level state of the virtual character. However, this is not limited thereto.

In one embodiment, the third state includes at least one of an attacked state, an attack state, a state in a danger zone, a state when driving a virtual vehicle, and a state when a virtual enemy character approaches, but is not limited thereto, which is not specifically limited in embodiments of this disclosure. In an implementation, operation 410 may be implemented as: The terminal displays, in response to the character state of the virtual character in the virtual environment being the attacked state, the HUD control in a perspective angle changing in a periodically shaking manner. For example, when the virtual character is attacked in the virtual environment, the terminal dynamically displays the HUD control within the range of the third perspective angle. For example, when the virtual character is in the attacked state, the range of the third perspective angle is 0° to 30°, and in this case, the HUD control dynamically changes and displays between 0° and 30°.

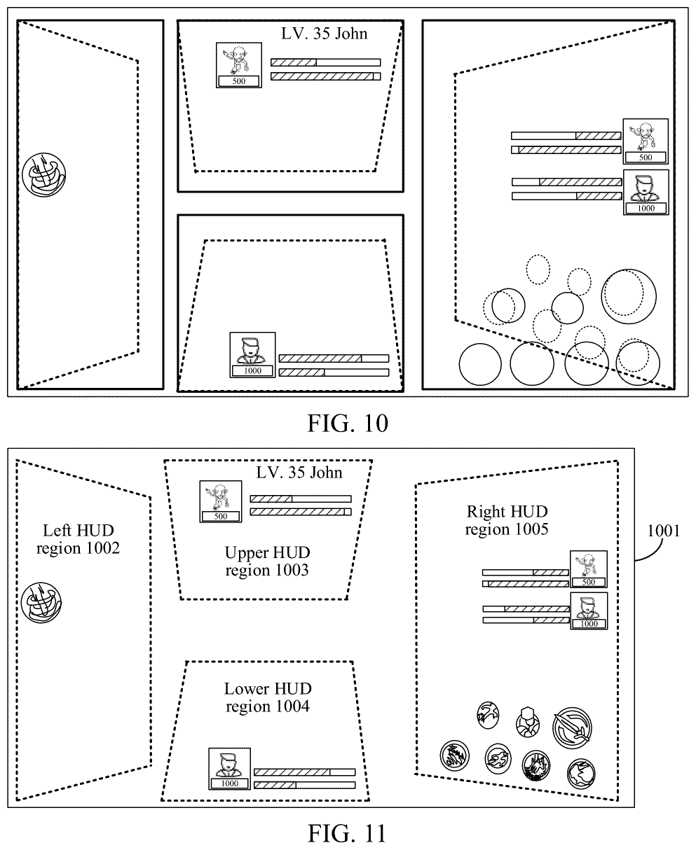

For example, FIG. 10 is a schematic diagram of displaying HUD controls in different perspective angles. At least one of the HUD controls including an operation control, an ammunition bar, a health bar, and virtual character information is displayed in the figure. When a virtual character is in an attacked state, the HUD controls are displayed between 0° and 30° in a perspective angle changing in a periodically shaking manner. For example, the HUD controls are displayed at 5° at 0.1 s, the HUD controls are displayed at 10° at 0.2 s, and the HUD controls are displayed at 15° at 0.3 s, but is not limited thereto, which is not specifically limited in embodiments of this disclosure. In a possible implementation, the HUD control includes at least two HUD controls located in at least two regions, and the HUD controls located in different regions correspond to different perspective angles.

For example, FIG. 11 is a schematic diagram of HUD controls in different regions. An HUD control 1001 in the figure is divided into four regions, which are a left HUD region 1002, an upper HUD region 1003, a lower HUD region 1004, and a right HUD region 1005, respectively. A terminal displays the HUD controls in different regions and in different perspective angles based on a character state of a virtual character. For example, when the virtual character is in a walking state and walks from left to right, a perspective angle corresponding to the left HUD region 1002 is 5°, a perspective angle corresponding to the upper HUD region 1003 is 0°, a perspective angle corresponding to the lower HUD region 1004 is 0°, and a perspective angle corresponding to the right HUD region 1005 is 15°.

For example, when the virtual character 103 is in an attacked state, and the range of the third perspective angle corresponding to the third state is 0° to 30°, state information and an operation control of the virtual character in the left HUD region 1002 dynamically change between 0° and 30°. Similarly, the HUD control in the upper HUD region 1003 dynamically changes between 0° and 30°, the HUD control in the lower HUD region 1004 dynamically changes between 0° and 30°, and the HUD control in the right HUD region 1005 dynamically changes between 0° and 30°. The HUD control may be divided into at least two regions. Four regions are used as an example in this embodiment of this disclosure, but is not limited thereto. The range of the third perspective angle corresponding to each region may be the same or different, which is not specifically limited in embodiments of this disclosure. The HUD controls in the regions may change synchronously or asynchronously when dynamically changing within the range of the third perspective angle, which is not specifically limited in embodiments of this disclosure. For example, the HUD control is divided into four regions, which are a left HUD region, an upper HUD region, a lower HUD region, and a right HUD region, respectively. When the virtual character is in a counterclockwise rotation state, a perspective angle corresponding to the left HUD region 1002 is opposite to a perspective angle corresponding to the right HUD region 1005. For example, the perspective angle corresponding to the left HUD region 1002 is −15°, the perspective angle corresponding to the upper HUD region 1003 is 0°, the perspective angle corresponding to the lower HUD region 1004 is 0°, and the perspective angle corresponding to the right HUD region 1005 is +15°, but is not limited thereto, which is not specifically limited in embodiments of this disclosure.

For example, the HUD control includes at least two HUD controls located in at least two regions, which rotate on an edge of the region near an imaging plane frame of the virtual environment picture as an axis, to obtain the HUD controls displayed in different perspective angles.

In an implementation, a shape feature of the HUD control changes based on the perspective angle. The corresponding perspective angle may be obtained based on a shape change of the HUD control displayed on the terminal. For example, based on a perspective principle, a rectangular control is stretched into a trapezoid, and a circular control is stretched into an oval. A perspective angle is determined based on a degree of the shape change of the HUD control whether there is the perspective angle. For example, a perspective angle is determined based on a change in an aspect ratio. The shape feature such as the aspect ratio of the HUD control is changed to provide a perspective display effect of the HUD control for a user. The user can determine the character state of the virtual character based on whether a shape of the HUD control changes, thereby improving efficiency of human-computer interaction.

In another implementation, an arrangement feature of the HUD control changes based on the perspective angle. The corresponding perspective angle may be obtained via connecting lines between a plurality of HUD controls displayed on the terminal. For example, center points of two HUD controls are connected, and a perspective angle is determined based on an angle change of the connecting line whether there is the perspective angle. A position feature of the HUD control is changed to provide perspective display effects of a plurality of HUD control for a user. The user can determine the character state of the virtual character based on whether a position of the HUD control changes. In an example, the aspect ratio of the HUD control in the foregoing implementation does not change, and the shape of the HUD control is not stretched. For example, a circular control is not stretched into an oval or another irregular shape due to the perspective angle. A habit of the user for operating a control is fully considered, to avoid a problem that the user cannot accurately identify the HUD control because of the shape change. In one embodiment, an area of the HUD control decreases as the perspective angle increases. This is similar to an impact of the perspective principle on display of the HUD control, and provides an immersive display experience for the user.

In another implementation, a visual feature of the HUD control changes based on the perspective angle. In an example, the visual feature includes a display parameter of the HUD control. The display parameter of the HUD control changes based on the perspective angle, such as having a positive or negative correlation with the perspective angle. The display parameter includes but is not limited to at least one of parameters of transparency, brightness, saturation, contrast, sharpness, color temperature, and the like. In another example, the visual feature includes an auxiliary display mark around the HUD control. The auxiliary display mark may be configured for improving visual significance of the HUD control, such as a highlighted line and graphic. The auxiliary display mark may be alternatively configured for improving a display effect of the HUD control, such as a line diverging from the HUD control, to simulate an effect of movement or rotation of the HUD control. A parameter such as a length and brightness of the auxiliary display mark changes based on the perspective angle.

In one embodiment, there is at least one overlapping pixel point between HUD controls displayed in different perspective angles. In other words, there is at least one overlapping pixel point located on HUD controls displayed in different perspective angles. Based on the overlapping pixel point, it is ensured that a display position of the HUD control does not shift significantly in different perspective angles. A habit of the user for operating a control is fully considered, to avoid a problem of difficult operation or misoperation caused by a positional shift of the HUD control in different perspective angle.

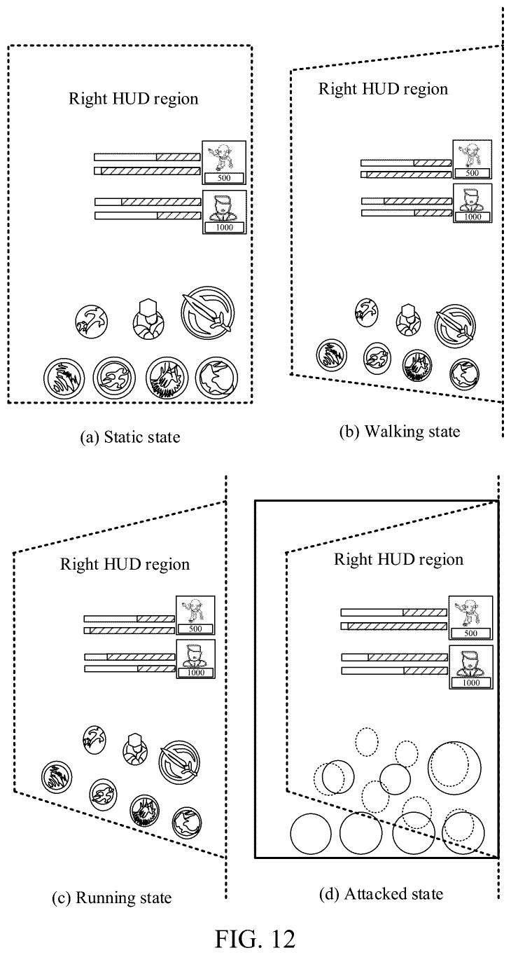

The foregoing various implementations can be implemented separately, or can be combined with each other to form different embodiments, which is not limited in this disclosure. For example, a HUD control is divided into four regions, which are a left HUD region, an upper HUD region, a lower HUD region, and a right HUD region, respectively. Using the right HUD region as an example, FIG. 12 is a schematic diagram of the right HUD region. As shown in section (a) of FIG. 12, when a virtual character is in a static state in a virtual environment, a perspective angle of an HUD control displayed by a terminal is 0°. As shown in section (b) of FIG. 12, when the virtual character switches from the static state to a walking state, the perspective angle of the HUD control displayed by the terminal switches from 0° to 10°. In other words, using a right edge line as an axis of rotation, the HUD control rotates 10° Clockwise. As shown in section (c) of FIG. 12, when the virtual character switches from the walking state to a running state, the perspective angle of the HUD control displayed by the terminal switches from 10° to 30°. In other words, using the right edge line as the axis of rotation, the HUD control further rotates 20° Clockwise. When the virtual character is in an attacked state, a range of a third perspective angle is 0° to 30°, and the HUD control 102 dynamically changes and displays between 0° and 30°. In other words, using the right edge line as the axis of rotation, the HUD control dynamically rotates between 0° and 30°.

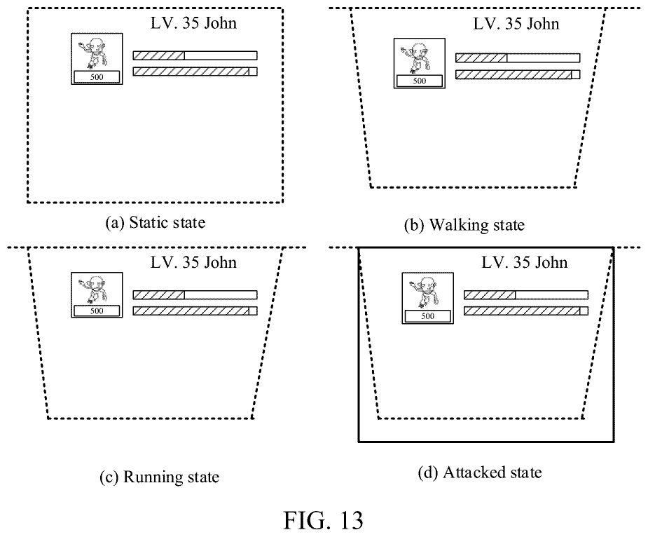

FIG. 13 is a schematic diagram of the upper HUD region. As shown in section (a) of FIG. 13, when a virtual character is in a static state in a virtual environment, a perspective angle of an HUD control displayed by a terminal is 0°. As shown in section (b) of FIG. 13, when the virtual character switches from the static state to a walking state, the perspective angle of the HUD control displayed by the terminal switches from 0° to 10°. In other words, using an upper edge line as an axis of rotation, the HUD control rotates 10° inward. As shown in section (c) of FIG. 13, when the virtual character switches from the walking state to a running state, the perspective angle of the HUD control displayed by the terminal switches from 10° to 30°. In other words, using the upper edge line as the axis of rotation, the HUD control further rotates 20° inward. When the virtual character is in an attacked state, a range of a third perspective angle is 0° to 30°, and the HUD control 102 dynamically changes and displays between 0° and 30°. In other words, using the upper edge line as the axis of rotation, the HUD control dynamically rotates between 0° and 30°.

FIG. 14 is a schematic diagram of the lower HUD region. As shown in section (a) of FIG. 14, when a virtual character is in a static state in a virtual environment, a perspective angle of an HUD control displayed by a terminal is 0°. As shown in section (b) of FIG. 14, when the virtual character switches from the static state to a walking state, the perspective angle of the HUD control displayed by the terminal switches from 0° to 10°. In other words, using a lower edge line as an axis of rotation, the HUD control rotates 10° inward. As shown in section (c) of FIG. 14, when the virtual character switches from the walking state to a running state, the perspective angle of the HUD control displayed by the terminal switches from 10° to 30°. In other words, using the lower edge line as the axis of rotation, the HUD control further rotates 20° inward. When the virtual character is in an attacked state, a range of a third perspective angle is 0° to 30°, and the HUD control 102 dynamically changes and displays between 0° and 30°. In other words, using the lower edge line as the axis of rotation, the HUD control dynamically rotates between 0° and 30°.

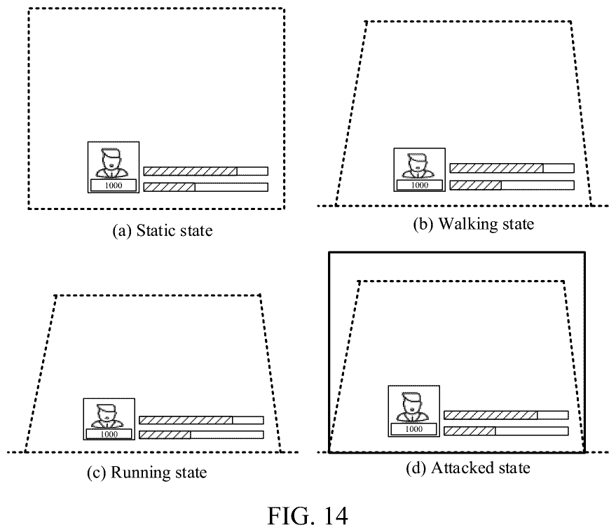

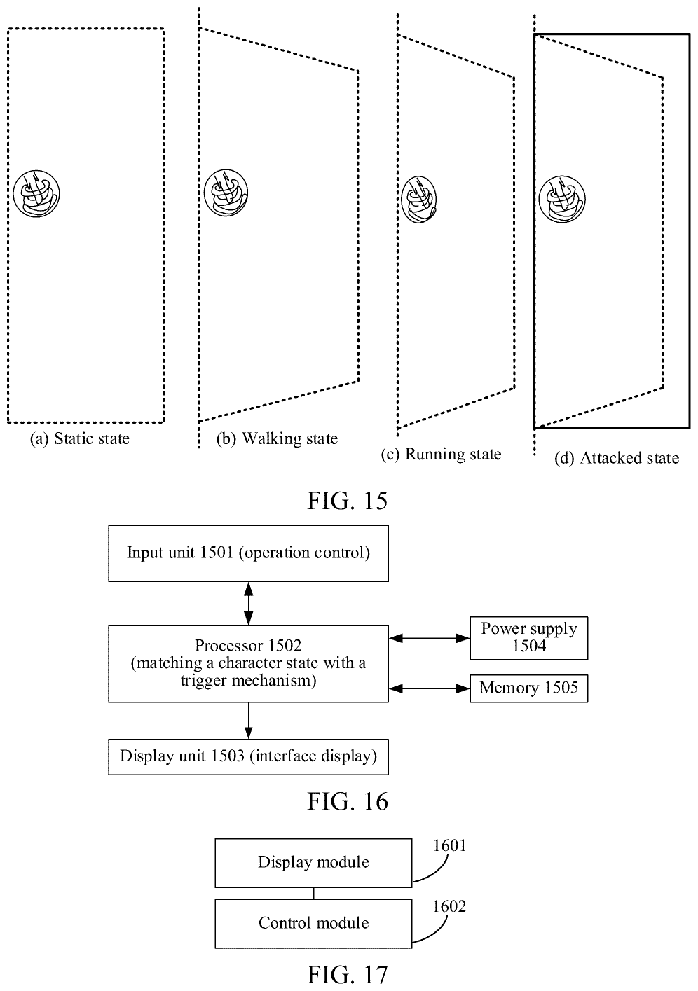

FIG. 15 is a schematic diagram of the left HUD region. As shown in section (a) of FIG. 15, when a virtual character is in a static state in a virtual environment, a perspective angle of an HUD control displayed by a terminal is 0°. As shown in section (b) of FIG. 15, when the virtual character switches from the static state to a walking state, the perspective angle of the HUD control displayed by the terminal switches from 0° to 10°. In other words, using a left edge line as an axis of rotation, the HUD control rotates 10° Counterclockwise. As shown in section (c) of FIG. 15, when the virtual character switches from the walking state to a running state, the perspective angle of the HUD control displayed by the terminal switches from 10° to 30°. In other words, using the left edge line as the axis of rotation, the HUD control further rotates 20° counterclockwise. When the virtual character is in an attacked state, a range of a third perspective angle is 0° to 30°, and the HUD control 102 dynamically changes and displays between 0° and 30°. In other words, using the left edge line as the axis of rotation, the HUD control dynamically rotates between 0° and 30°. In a possible implementation, the HUD control includes an operation control. The terminal displays the HUD control having different perspective angles in response to a trigger operation of the operation control. For example, the operation control is configured to adjust the perspective angle of the HUD control. In one embodiment, the trigger operation includes any one of a tap/click operation, a continuous touch operation, and a slide operation, but is not limited thereto, which is not specifically limited in embodiments of this disclosure.

In one embodiment, the operation control includes a first type of operation control. The terminal changes, in response to a trigger operation of the first type of operation control, the perspective angle of the HUD control to a corresponding perspective angle after the first type of operation control is triggered.

For example, the terminal changes, in response to a trigger operation of a walking control or a running control, the perspective angle of the HUD control to a corresponding perspective angle after the walking control or the running control is triggered. For example, after an object triggers the walking control, the perspective angle of the HUD control displayed by the terminal is 10°.

In one embodiment, the operation control includes a second type of operation control. The terminal displays the HUD control in a dynamically changing perspective angle in response to a trigger operation of the second type of operation control. The dynamically changing perspective angle is within a range of a perspective angle corresponding to the second type of operation control. For example, the terminal changes, in response to a trigger operation of an attack control or a defense control, the perspective angle of the HUD control to a corresponding perspective angle after the attack control or the defense control is triggered. For example, after the object triggers the attack control, the terminal dynamically changes the HUD control between 0° and 30°.

In conclusion, in the method provided in this embodiment, a virtual environment picture and a heads-up display HUD control are displayed; a virtual character is controlled to carry out an action in a virtual environment; and the HUD control in different perspective angles and corresponding to a plurality of character states is displayed based on the plurality of character states of the virtual character. This disclosure provides a new information display method. An information display mode of the HUD control is associated with the character state of the virtual character, and the HUD control is displayed based on different perspective angles, to assist a user in determining the character state of the virtual character based on the perspective angles, thereby improving efficiency of human-computer interaction and user experience.

FIG. 16 is a block diagram of a structure of a terminal for processing information in a virtual environment according to an exemplary embodiment of this disclosure. The terminal includes an input unit 1501, a processor 1502, a display unit 1503, a power supply 1504, and a memory 1505.

The input unit 1501 may be an operation control. An object can input information to the input unit 1501 by pressing a button or buttons in one or more operation controls; the object inputs information to the input unit 1501 by using a virtual joystick on a terminal interface; the object inputs information to the input unit 1501 by using an external device (such as a handle, VR glasses, or a VR helmet) connected to the terminal; the object controls, through voice, a virtual character to carry out an action; or the object inputs information to the input unit 1501 through a motion sensing operation. The processor 1502 may include one or more processing cores, for example, a 4-core processor or an 8-core processor. In some embodiments, the processor 1502 may further include an artificial intelligence (AI) processor. The AI processor is configured to process computing operations related to machine learning. The processor 1502 processes the information received by the input unit 1501 and matches a state of the virtual character with a trigger mechanism.

The display unit 1503 is configured to display a virtual environment picture and a heads-up display HUD control.

The power supply 1504 is configured to supply power to various components in the terminal for processing information in a virtual environment.

The memory 1505 may include one or more computer-readable storage media. The computer-readable storage medium may be tangible and non-transient. The memory 1505 may further include a high-speed random access memory and a nonvolatile memory, for example, one or more disk storage devices or flash storage devices. In some embodiments, the non-transitory computer-readable storage medium in the memory 1505 is configured to store at least one instruction. The at least one instruction is configured for being executed by the processor 1505 to implement the method for processing information in a virtual environment in embodiments of this disclosure.

FIG. 17 is a schematic diagram of a structure of an apparatus for processing information in a virtual environment according to an exemplary embodiment of this disclosure. The apparatus may be implemented as all or a part of a computer device by software, hardware, or a combination of the two. The apparatus includes:

a display module 1601, configured to display a virtual environment picture and a heads-up display HUD control, the virtual environment picture being for displaying a virtual environment, and the HUD control being configured to display user interface UI information required for controlling a virtual character; and

a control module 1602, configured to control the virtual character to carry out an action in the virtual environment.

The display module 1601 is further configured to display the HUD control having different perspective angles based on a character state of the virtual character. The perspective angle is an included angle between the HUD control and an imaging plane of the virtual environment picture.

In a possible implementation, the display module 1601 is further configured to: change the perspective angle of the HUD control from a first perspective angle to a second perspective angle in response to the character state of the virtual character changing from a first state to a second state, the first perspective angle corresponding to the first state, and the second perspective angle corresponding to the second state.

The first state is a walking state, and the second state is a running state.

In a possible implementation, the display module 1601 is further configured to: change the perspective angle of the HUD control from the first perspective angle to the second perspective angle in response to the character state of the virtual character changing from the walking state to the running state, the second perspective angle being greater than the first perspective angle.

In a possible implementation, the display module 1601 is further configured to: change the perspective angle of the HUD control in response to an attribute parameter change of the character state of the virtual character.

In a possible implementation, the display module 1601 is further configured to: increase the perspective angle of the HUD control in response to an increase in speed or acceleration of the virtual character in the virtual environment.

In a possible implementation, the display module 1601 is further configured to: decrease the perspective angle of the HUD control in response to a decrease in speed or acceleration of the virtual character in the virtual environment.

In a possible implementation, the display module 1601 is further configured to: display the HUD control in a dynamically changing perspective angle in response to the character state of the virtual character being a third state.

The dynamically changing perspective angle is within a range of a third perspective angle corresponding to the third state.

The third state is an attacked state. In a possible implementation, the display module 1601 is further configured to display, in response to the character state of the virtual character in the virtual environment being the attacked state, the HUD control in a perspective angle changing in a periodically shaking manner. The HUD control includes at least two HUD controls located in at least two regions, and the HUD controls located in different regions correspond to different perspective angles. The HUD control includes an operation control.

In a possible implementation, the display module 1601 is further configured to: display the HUD control having different perspective angles in response to a trigger operation of the operation control. The operation control includes a first type of operation control.

In a possible implementation, the display module 1601 is further configured to change, in response to a trigger operation of the first type of operation control, the perspective angle of the HUD control to a corresponding perspective angle after the first type of operation control is triggered. The operation control includes a second type of operation control.

In a possible implementation, the display module 1601 is further configured to: display the HUD control in a dynamically changing perspective angle in response to a trigger operation of the second type of operation control.

The dynamically changing perspective angle is within a range of a perspective angle corresponding to the second type of operation control.

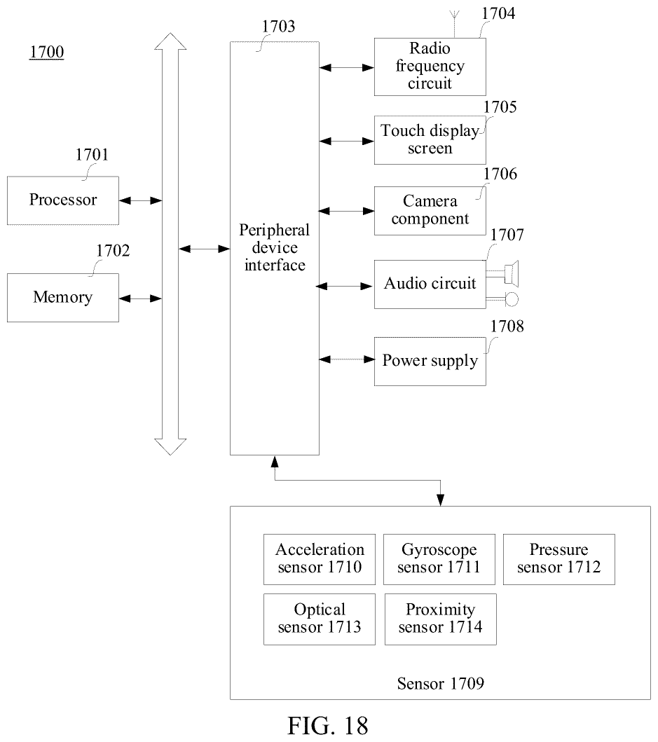

FIG. 18 is a block diagram of a structure of a computer device 1700 according to an exemplary embodiment of this disclosure. The computer device 1700 may be a portable mobile terminal, such as a smart phone, a tablet computer, a Moving Picture Experts Group Audio Layer III (MP3) player, or a Moving Picture Experts Group Audio Layer IV (MP4) player. The computer device 1700 may also be referred to as another name such as user equipment or a portable terminal.

The computer device 1700 includes processing circuitry, such as a processor 1701, and a memory 1702.

The processor 1701 may include one or more processing cores, for example, a 4-core processor or an 8-core processor. The processor 1701 may be implemented in at least one hardware form among a digital signal processor (DSP), a field programmable gate array (FPGA), and a programmable logic array (PLA). The processor 1701 may also include a main processor and a coprocessor. The main processor is a processor configured to process data in an awake state, and is also referred to as a central processing unit (CPU). The coprocessor is a low-power processor configured to process data in a standby state. In some embodiments, the processor 1701 may be integrated with a graphics processing unit (GPU). The GPU is configured to render and draw content that needs to be displayed on a display screen. In some embodiments, the processor 1701 may further include an artificial intelligence (AI) processor. The Al processor is configured to process computing operations related to machine learning. The memory 1702 may include one or more computer-readable storage media. The computer-readable storage medium may be tangible and non-transient. The memory 1702 may further include a high-speed random access memory and a nonvolatile memory, for example, one or more disk storage devices or flash storage devices. In some embodiments, the non-transitory computer-readable storage medium in the memory 1702 is configured to store at least one instruction. The at least one instruction is configured for being executed by the processor 1701 to implement the method for processing information in a virtual environment in embodiments of this disclosure.

In some embodiments, the computer device 1700 may alternatively include a peripheral device interface 1703 and at least one peripheral device. Specifically, the peripheral device includes at least one of a radio frequency circuit 1704, a touch display screen 1705, a camera component 1706, an audio circuit 1707, and a power supply 1708. The peripheral device interface 1703 may be configured to connect the at least one peripheral device related to input/output (I/O) to the processor 1701 and the memory 1702. In some embodiments, the processor 1701, the memory 1702, and the peripheral device interface 1703 are integrated on the same chip or circuit board. In some other embodiments, any one or two of the processor 1701, the memory 1702, and the peripheral device interface 1703 may be implemented on a single chip or circuit board, which is not limited in this embodiment. The radio frequency circuit 1704 is configured to receive and transmit a radio frequency (RF) signal, also referred to as an electromagnetic signal. The radio frequency circuit 1704 communicates with a communication network and another communication device through the electromagnetic signal. The radio frequency circuit 1704 may further include a circuit related to near field communication (NFC). The touch display screen 1705 is configured to display a user interface (UI). The UI may include a graph, text, an icon, a video, and any combination thereof. The camera component 1706 is configured to capture images or videos. In one embodiment, the camera component 1706 includes a front-facing camera and a rear-facing camera. The audio circuit 1707 is configured to provide an audio interface between a user and the computer device 1700. The audio circuit 1707 may include a microphone and a speaker. The microphone is configured to acquire sound waves of a user and an environment, and convert the sound waves into an electrical signal to input to the processor 1701 for processing, or input to the radio frequency circuit 1704 for implementing voice communication. The power supply 1708 is configured to supply power to various components in the computer device 1700. The power supply 1708 may be an alternating current, a direct current, a disposable battery, or a rechargeable battery.

In some embodiments, the computer device 1700 further includes one or more sensors 1709. The one or more sensors 1709 include but are not limited to an acceleration sensor 1710, a gyroscope sensor 1711, a pressure sensor 1712, an optical sensor 1713, and a proximity sensor 1714. The acceleration sensor 1710 may detect a magnitude of acceleration on three coordinate axes of a coordinate system established by the computer device 1700. The gyroscope sensor 1711 may detect a body direction and a rotation angle of the computer device 1700. The pressure sensor 1712 may be disposed at a side frame of the computer device 1700 and/or a lower layer of the touch display screen 1705, to detect a holding signal of a user on the computer device 1700, and/or control an operable control on the UI interface according to a pressure operation performed by the user on the touch display screen 1705. The optical sensor 1713 is configured to acquire ambient light intensity. The proximity sensor 1714, also referred to as a distance sensor, is generally disposed on a front surface of the computer device 1700. The proximity sensor 1714 is configured to acquire a distance between a user and the front surface of the computer device 1700.

It is noted that the structure shown in FIG. 18 does not constitute a limitation on the computer device 1700, and the computer device 1700 may include more components or fewer components than those shown in the figure, or some components may be combined, or a different component deployment may be used.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

An embodiment of this disclosure further provides a computer device. The computer device includes a processor and a memory, the memory having at least one computer program stored therein, and the at least one computer program being loaded and executed by the processor to implement the method for processing information in a virtual environment provided in the foregoing method embodiments.

An embodiment of this disclosure further provides a computer storage medium, such as a non-transitory computer-readable storage medium, having at least one computer program stored thereon, the at least one computer program being loaded and executed by a processor to implement the method for processing information in a virtual environment provided in the foregoing method embodiments.

An embodiment of this disclosure further provides a computer program product, including a computer program, the computer program being stored on a computer-readable storage medium, and the computer program being read from the computer-readable storage medium and executed by a processor of a computer device, to enable the computer device to perform the method for processing information in a virtual environment provided in the foregoing method embodiments.

What is claimed is:

1. A method for processing information, comprising:
generating a virtual environment image for a virtual environment that includes a virtual character carrying out an action in the virtual environment;
determining a perspective angle for displaying a heads-up display (HUD) control with the virtual environment image based on a character state of the virtual character and a region of the virtual environment image for the HUD control, the HUD control providing user interface (UI) information for controlling the virtual character, the perspective angle being an included angle between the HUD control and an imaging plane of the virtual environment image; and
displaying the virtual environment image with the HUD control in the region of the virtual environment image according to the perspective angle.

2. The method according to claim 1, wherein the determining the perspective angle comprises:
changing the perspective angle of the HUD control from a first perspective angle to a second perspective angle when the character state of the virtual character changes from a first state to a second state, the first perspective angle corresponding to the first state, and the second perspective angle corresponding to the second state.

3. The method according to claim 2, wherein the first state is a walking state, and the second state is a running state, the changing the perspective angle comprises:
changing the perspective angle of the HUD control from the first perspective angle to the second perspective angle when the character state of the virtual character changes from the walking state to the running state, the second perspective angle being greater than the first perspective angle.

4. The method according to claim 1, wherein the determining the perspective angle comprises:
changing the perspective angle of the HUD control when an attribute parameter of the character state of the virtual character changes.

5. The method according to claim 4, wherein the changing the perspective angle of the HUD control comprises:
increasing the perspective angle of the HUD control when a speed or an acceleration of the virtual character increases in the virtual environment.

6. The method according to claim 4, wherein the changing the perspective angle comprises:
decreasing the perspective angle of the HUD control when a speed or an acceleration of the virtual character decreases in the virtual environment.

7. The method according to claim 1, further comprising:
varying, when the character state of the virtual character is a third state, a plurality of perspective angles of the HUD control for respectively displaying in a plurality of virtual environment images dynamically in a range.

8. The method according to claim 7, wherein the third state is an attacked state, and the method further comprises:
displaying, when the character state of the virtual character in the virtual environment is the attacked state, the plurality of virtual environment images with the plurality of perspective angles of the HUD control changing in a periodically shaking manner.

9. The method according to claim 1, wherein the determining the perspective angle further comprises:
determining a first perspective angle for displaying a first HUD control with the virtual environment image based on the character state of the virtual character and a first region of the virtual environment image for the first HUD control; and
determining a second perspective angle for displaying a second HUD control with the virtual environment image based on the character state of the virtual character and a second region of the virtual environment image for the second HUD control.

10. The method according to claim 1, wherein the HUD control comprises an operation control, and the method further comprises:
determining, in response to a trigger operation of the operation control, the perspective angle for displaying the HUD control with the virtual environment image according to the operation control.

11. The method according to claim 10, wherein
the operation control comprises a first type of operation control, and the determining the perspective angle further comprises:
changing, in response to the trigger operation of the first type of operation control, the perspective angle for displaying the HUD control to a corresponding perspective angle of the first type of operation control.

12. The method according to claim 10, wherein the operation control comprises a second type of operation control, and the determining the perspective angle further comprises:
varying corresponding perspective angles of the HUD control for displaying with a plurality of virtual environment images dynamically in a range in response to a trigger operation of the second type of operation control.

13. An apparatus for processing information, comprising processing circuitry configured to:
generate a virtual environment image for a virtual environment that includes a virtual character carrying out an action in the virtual environment;
determine a perspective angle for displaying a heads-up display (HUD) control with the virtual environment image based on a character state of the virtual character and a region of the virtual environment image for the HUD control, the HUD control providing user interface (UI) information for controlling the virtual character, the perspective angle being an included angle between the HUD control and an imaging plane of the virtual environment image; and
display the virtual environment image with the HUD control in the region of the virtual environment image according to the perspective angle.

14. The apparatus according to claim 13, wherein the processing circuitry is configured to:
change the perspective angle of the HUD control from a first perspective angle to a second perspective angle when the character state of the virtual character changes from a first state to a second state, the first perspective angle corresponding to the first state, and the second perspective angle corresponding to the second state.

15. The apparatus according to claim 14, wherein the first state is a walking state, the second state is a running state, and the processing circuitry is configured to:
change the perspective angle of the HUD control from the first perspective angle to the second perspective angle when the character state of the virtual character changes from the walking state to the running state, the second perspective angle being greater than the first perspective angle.

16. The apparatus according to claim 13, wherein the processing circuitry is configured to:
change the perspective angle of the HUD control when an attribute parameter of the character state of the virtual character changes.

17. The apparatus according to claim 16, wherein the processing circuitry is configured to:
increase the perspective angle of the HUD control when a speed or an acceleration of the virtual character increases in the virtual environment.

18. The apparatus according to claim 16, wherein the processing circuitry is configured to:
decrease the perspective angle of the HUD control when a speed or an acceleration of the virtual character decreases in the virtual environment.

19. The apparatus according to claim 13, wherein the processing circuitry is configured to:
vary, when the character state of the virtual character is a third state, a plurality of perspective angles of the HUD control for displaying in a plurality of virtual environment images dynamically in a range.

20. A non-transitory computer-readable storage medium storing instructions which when executed by at least one processor cause the at least one processor to perform:
generating a virtual environment image for a virtual environment that includes a virtual character carrying out an action in the virtual environment;
determining a perspective angle for displaying a heads-up display (HUD) control with the virtual environment image based on a character state of the virtual character and a region of the virtual environment image for the HUD control, the HUD control providing user interface (UI) information for controlling the virtual character, the perspective angle being an included angle between the HUD control and an imaging plane of the virtual environment image; and
displaying the virtual environment image with the HUD control in the region of the virtual environment image according to the perspective angle.
